(19) United States
(12) Patent Application Publication
(10) Pub. No.: US 2019/0160593 A1
(43) Pub. Date: May 30, 2019

(54) WELDING METHOD FOR DIFFERENT KINDS OF METALS

(71) Applicant: YAZAKI CORPORATION, Tokyo (JP)

(72) Inventors: Makoto KOSHIISHI, Shizuoka (JP); Kazuhide TAKAHASHI, Shizuoka (JP)

(73) Assignee: YAZAKI CORPORATION, Tokyo (JP)

(21) Appl. No.: 16/197,581

(22) Filed: Nov. 21, 2018

(30) Foreign Application Priority Data
Nov. 27, 2017 (JP) 2017-226540

(51) Int. Cl. B23K 26/323; B23K 26/21

(52) U.S. Cl. CPC B23K 26/323; B23K 2103/18; B23K 26/21

(57) ABSTRACT

A welding method includes: heating a second metal by a heater, the second metal having a melting point higher than that of a first metal; welding the first metal and the second metal in accordance with a heat amount to melt the first metal in a state where the second. metal is heated

### CROSS REFERENCE TO RELATED APPLICATIONS

The present application claims priority to Japanese Patent Application No. 2017-226540 filed on Nov. 27, 2017, the entire contents of which are incorporated by reference herein.

### BACKGROUND

### Technical Field

The present invention relates to a method for welding different kinds of metals having different melting points to each other.

### Related Art

FIGS. 3 and 4 illustrate exemplary cases in which different kinds of metals having different melting points are welded to each other by a laser beam.

As shown in FIG. 3, a first metal is set on a second metal. The first metal is an aluminum plate having a melting point of 660 degrees Celsius, for example. The second metal 2 is a copper plate having a melting point of 1080 degrees Celsius. When a laser beam 5 tuned to have a heat amount (an energy) which melts the first metal is irradiated to the first and second metals, the heat amount cannot heat the second metal 2 to a melting temperature of the second metal 2, thereby the welding of the above two metals cannot be successfully carried out.

In order to deal with this problem, as shown in FIG. 4, it is conceivable that a second metal 2 is placed on the first metal 1, and a laser beam 5 having a heat amount which melts the second metal 2 is irradiated to weld both metals.

### SUMMARY

In the welding method for the different kinds of metals as shown in FIG. 4, the laser beam 5 can melt the portion of the second metal 2 at which the laser beam 5 is irradiated. However, due to the irradiation of the laser beam , 5, the heat amount exceeding the melting point of the first metal 1 is transferred to a whole of the first metal 1. Therefore, in addition to the portion irradiated with the laser beam 5, the entire first metal 1 is melted, and the welding cannot be carried out.

The present invention has been made to solve the above-described problems, and it is an object of the present invention to provide a welding method for different kinds of metals capable of easily and reliably welding two kinds of metals having different melting points.

An aspect of the present invention is a welding method including: heating a second metal by a heater, the second metal having a melting point higher than that of a first metal; and welding the first metal and the second metal in accordance with an heat amount to melt the first metal in a state where the second metal is heated.

According to the present invention, it is possible to provide a welding method for different kinds of metals capable of easily and reliably welding two kinds of metals having different melting points.

### BRIEF DESCRIPTION OF DRAWINGS

FIG. 1A to FIG. 1C are process diagrams schematically showing a welding process of different kinds of metals according to a first embodiment of the present invention.

FIG. 2A to FIG. 2C are process diagrams schematically showing a welding process of different kinds of metals according to a second embodiment of the present invention.

FIG. 3 is a schematic diagram of a conventional welding method for different kinds of metals.

FIG. 4 is a schematic view of another conventional welding method for different kinds of metals.

### DETAILED DESCRIPTION

Embodiments of the present invention will be described below with reference to the drawings.

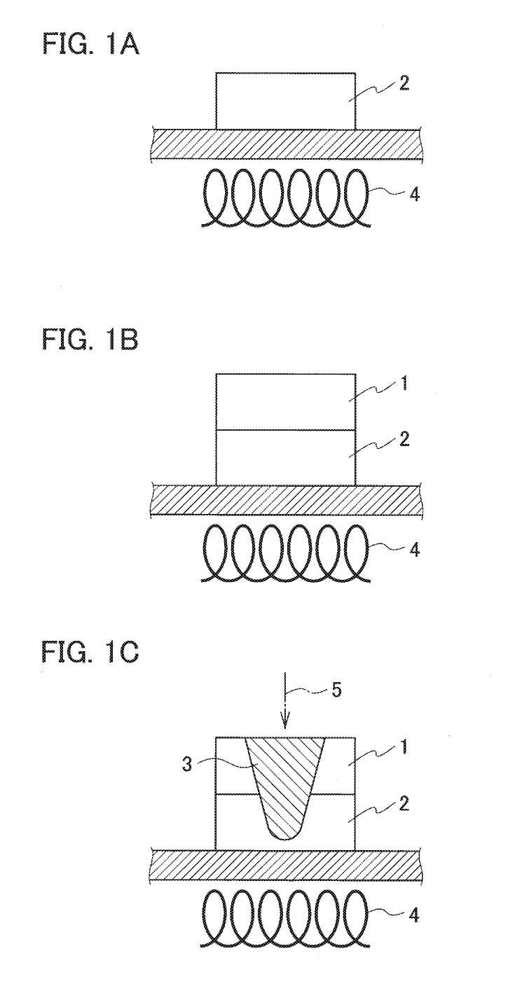

FIGS. 1A to 1C are process diagrams schematically showing a welding process of different kinds of metals according to a first embodiment of the present invention.

It is assumed that the first metal 1 and the second metal 2 are joined to each other by welding them. The first metal 1 is a low melting point metal, for example, an aluminum plate having a melting point of 660 degrees Celsius. The second metal 2 has a high melting point metal having a melting point higher than the first metal 1, for example, a copper plate of a melting point 1080 degrees Celsius. First, as shown in FIG. 1A, the second metal 2 is heated in advance by a heater (heating device) 4. The second metal 2 is heated so that a heat amount corresponding to a temperature difference between a predetermined temperature of the second metal 2 and a predetermined temperature of the first metal 1 is given to the second metal 2. Here, the predetermined temperature of the second metal 2 is, for example, a melting point of the second metal 2 (i.e. 1080 degrees Celsius), and the predetermined temperature of the first metal 1 is, for example, a melting point of the first metal 1 (i.e. 660 degrees Celsius). Therefore, the temperature difference in this case is 420 degrees Celsius.

Next, as shown in FIG. 1B, the first metal 1 is placed on the heated second metal 2. Then, welding of the first metal and the second metal is carried out in accordance with a heat amount to melt the first metal 1 in a state where the second metal 2 is heated. For example, as shown in FIG. 1C, the first metal 1 is irradiated with a laser beam 5 having a heat amount (an energy) which melts the first metal 1 while the second metal 2 is heated, and the welding is carried out. From a state where the second metal 2 is heated, the heat amount of the laser beam (for example, YAG laser) 5 is given to the second metal 2, the second metal 2 reaches a temperature at which the second metal 2 melts, thereby the first metal 1 and the second metal 2 simultaneously melt. Accordingly, it is possible to weld both metals 1 and 2. Here, FIG. 1C indicates the welded portion by a reference number 3.

While the second metal 2 is heated, the heat may be transferred to the first metal 1. Therefore, the following (1) or (2), or both measures are taken.

(1) While the second metal 2 is heated, as shown in FIG. 1A, a first metal 1 is set away from the second metal 2 to prevent heat conduction to the first metal 1. Thereafter, as shown in FIG. 1B, the first metal 1 is placed to be in contact with the second metal 2, and the welding by the irradiation of the laser beam 5 is carried out at the same time when the first metal 1 is set on the second metal 2.

(2) A heat radiation plate (radiating plate) (not shown) is placed on the first metal 1 to dissipate the heat transmitted from the heated second metal 2.

As described above, the second metal 2 is heated in advance with the heat amount corresponding to the temperature difference between the melting point of the second metal 2 and the melting point of the first metal 1 by using the heater 4. With this heating, the second metal 2 reaches the melting point by the heat amount melting the first metal 1 of laser welding and the heat amount supplied from the heater 4. By such laser welding, it is possible to weld the first metal 1 and the second metal 2 having different melting points easily and reliably. In addition, laser welding can be carried out without processing the first metal 1 and the second metal 2 into specific shapes.

2A to 2C are process diagrams schematically showing a welding process of different kinds of metals according to a second embodiment of the present invention.

In the first embodiment, laser welding is carried out by placing the first metal 1 on the heated second metal 2. On the other hand, in the second embodiment, the first metal 1 is placed beside the heated second metal 2 and laser welding is carried out. That is, when the second metal 2 is heated by the heater 4, the first metal 1 is set away from the second metal 2 to prevent heat conduction to the first metal 1, and then the first metal 1 is placed to be in contact with the second metal 2. At the same time, laser welding is carried out by irradiation with the laser beam 5. The second embodiment is the same as the first embodiment except for the above difference. Therefore, the same components are denoted by the same reference numerals, and a detailed description thereof will be omitted.

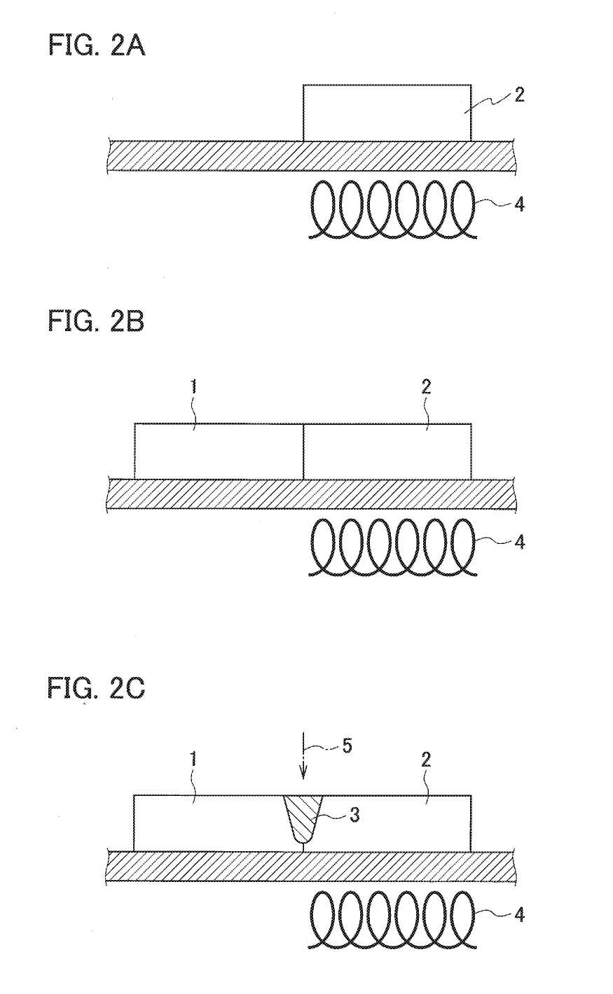

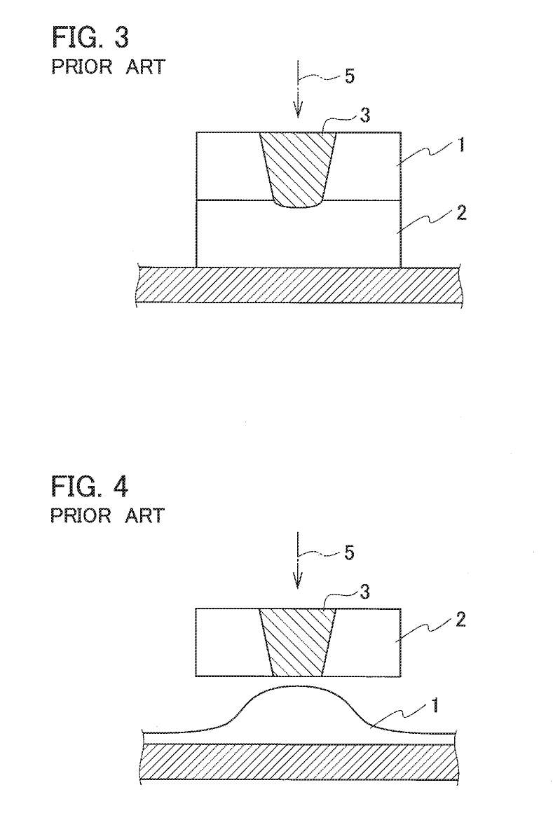

Also in this second embodiment, as shown in FIGS. 2A and 2B, the second metal 2 is heated in advance with the heat amount corresponding to the temperature difference between the melting point of the second metal 2 and the melting point of the first metal 1 by using the heater 4. With this heating, the second metal 2 reaches the melting point by the heat amount melting the first metal 1 of laser welding and the heat amount supplied from the heater 4. By such laser welding, it is possible to weld the first metal 1 and the second metal 2 having different melting points easily and reliably. FIG. 2C indicates the welded portion by a reference number 3. In addition, laser welding can be carried out without processing the first metal 1 and the second metal 2 into a specific shape.

In each of the above embodiments, the refractory metal and the low melting point metal were welded by irradiation with a laser beam. However, resistance welding using a pair of electrodes or the like may be carried out on the refractory metal and the low melting point metal.

In addition, the high melting point metal is not limited to the above-mentioned copper plate, and may be other metal (alloy) . The high melting point metal may be a carbon steel plate having a melting point of 1500 degrees Celsius, for example. The low melting point metal is not limited to the above-mentioned aluminum plate, and may be other metal (alloy). The low melting point metal may be a brass plate having a melting point of 900 degrees Celsius, for example. The shapes of the high melting point metal and the low melting point metal are not limited to the plate shape.

What is claimed is:

1. A welding method comprising:
heating a second metal by a heater, the second metal having a melting point higher than that of a first metal; and
welding the first metal and the second metal in accordance with an heat amount to melt the first metal in a state where the second metal is heated.

2. The welding method according to claim 1, wherein
the second metal is heated with an heat amount corresponding to a temperature difference between a melting point of the second metal and a melting point of the first metal, and
the first metal and the second metal are welded by an irradiation of a laser beam.

3. The welding method according to claim 2, wherein
the first metal is set away from the second metal in the heating of the second metal by the heater,
thereafter the first metal is placed to be in contact with the second metal, and
the welding by the irradiation of the laser beam is carried out at the same time when the first metal is set.

4. The welding method according to claim 1, wherein
a heat radiation plate is placed on the first metal in the heating of the second metal by the heater.

5. The welding method according to claim 2, wherein
a heat radiation plate is placed on the first metal in the heating of the second metal by the heater.
